(19) United States
(12) Patent Application Publication
(10) Pub. No.: US 2007/0069490 A1
(43) Pub. Date: Mar. 29, 2007

(54) Sharps container configured for cart mounting

(76) Inventors: John Japuntich, Harvard, IL (US); Anton M. Smudde, Elk Grove Village, IL (US); Mark Brian Finnestad, Huntley, IL (US)

Correspondence Address: RATNERPRESTIA, P O BOX 980, VALLEY FORGE, PA, 19482-0980, US

(21) Appl. No.: 11/234,630

(22) Filed: Sep. 23, 2005

(51) Int. Cl. B62B 3/10

(52) U.S. Cl. 280/47.35

(57) ABSTRACT

A disposable or reusable medical implement container configured to receive soiled medical implements is provided. The medical implement container comprises a body portion having a dimension (in) measured along a longitudinal axis and a cross sectional area (in²) measured in a plane perpendicular to the longitudinal axis of the body portion, wherein a ratio of the dimension (in) of the body portion to the cross-sectional area (in²) of the body portion is about 0.3:1 or greater.

### FIELD OF THE INVENTION

The present invention relates to a sharps container configured for mounting onto a transportable medical cart.

### BACKGROUND OF THE INVENTION

In a hospital, doctor's office, surgicenter, long-term care facility or other health care facility, soiled sharps or other disposable medical implements are commonly deposited in a disposal container following their use. The disposal containers may be mounted onto a wall, positioned on a floor surface, or, for convenience purposes, mounted onto a transportable cart. While carts have been proposed for use in hospital and doctor's office settings, there remains a need for improved cart systems.

### SUMMARY OF THE INVENTION

In one exemplary embodiment, a medical implement container configured to receive soiled medical implements is provided. The medical implement container comprises a body portion having a dimension (in) measured along a longitudinal axis and a cross sectional area (in²) measured in a plane perpendicular to the longitudinal axis of the body portion, wherein a ratio of the dimension (in) of the body portion to the cross-sectional area (in²) of the body portion is about 0.3:1 or greater.

In another exemplary embodiment, a medical cart assembly is provided. The medical cart assembly comprises a medical cart having a base surface, a top surface, and an area positioned between the base surface and the top surface for storage of medical supplies. At least one container that is configured to receive soiled medical implements is positioned on the base surface of the medical cart external of the storage area. A base surface of the container is positioned on the base surface of the medical cart and a top surface of the container is substantially aligned with or extends above the top surface of the medical cart to facilitate the deposition of soiled medical implements into the container.

In yet another exemplary embodiment, a method of facilitating the disposal of medical implements is provided. The method comprises the step of storing medical supplies in an area positioned between a base surface and a top surface of a medical cart. A container is positioned on the cart external of the storage area such that a base portion of the container is positioned on the base surface of the cart and a top portion of the container is substantially aligned with or extends above the top surface of the cart.

### BRIEF DESCRIPTION OF THE DRAWINGS

The invention is best understood from the following detailed description when read in connection with the accompanying drawing. It is emphasized that, according to common practice, the various features of the drawing may not be to scale. On the contrary, the dimensions of the various features may be arbitrarily expanded or reduced for clarity. Included in the drawing is the following figure:

FIG. 1 is a perspective view from the top right of an exemplary embodiment of an assembly including two sharps containers mounted onto a cart according to aspects of this invention;

FIG. 2 is an elevation view from the left side of the assembly illustrated in FIG. 1;

FIG. 3 is a top plan view of the assembly illustrated in FIG. 1;

FIG. 4 is a front elevation view of the assembly illustrated in FIG. 1;

FIG. 5 is a rear elevation view of the sharps container of FIG. 1 (cap omitted);

FIG. 6 is a bottom plan view of the sharps container of FIG. 5; and

FIG. 7 is a top plan view of the sharps container of FIG. 5.

### DETAILED DESCRIPTION OF THE INVENTION

The invention will next be illustrated with reference to the Figures. Such Figures are intended to be illustrative rather than limiting and are included herewith to facilitate explanation of the present invention. The Figures are not to scale, and are not limited to the proportions illustrated in the Figures.

Referring generally to the figures, and according to one exemplary embodiment, a medical implement container 20 configured to receive soiled medical implements is provided. The medical implement container 20 comprises a body portion 21 having a dimension H₂ (in) measured along a longitudinal axis L and a cross sectional area (in²) measured in a plane perpendicular to the longitudinal axis L of the body portion 21, wherein a ratio of the dimension H₂ (in) of the body portion 21 to the cross-sectional area (in²) of the body portion 21 is about 0.3:1 or greater.

In another exemplary embodiment, a medical cart assembly 10 is provided. The medical cart assembly 10 comprises a medical cart 30 having a base surface 46, a top surface 34, and a substantially enclosed storage area 40, 42 positioned between the base surface 46 and the top surface 34 for storage of medical supplies. At least one container 20 that is configured to receive soiled medical implements is positioned on the base surface 46 of the medical cart 30 external of the storage area 40, 42. A base surface 24 of the container 20 is positioned on the base surface 46 of the medical cart 30 and a top surface 22 of the container 20 is substantially aligned with or extends above the top surface 34 of the medical cart 30 to facilitate the deposition of soiled medical implements into the container 20.

In yet another exemplary embodiment, a method of facilitating the disposal of medical implements is provided. The method comprises the step of storing medical supplies in an area 40, 42 positioned between a base surface 46 and a top surface 34 of a medical cart 30. A container 20 is positioned on the cart 30 external of the storage area 40, 42 such that a base portion 24 of the container 20 is positioned on the base surface 46 of the cart 30 and a top portion 22 of the container 20 is substantially aligned with or extends above the top surface 34 of the cart 30.

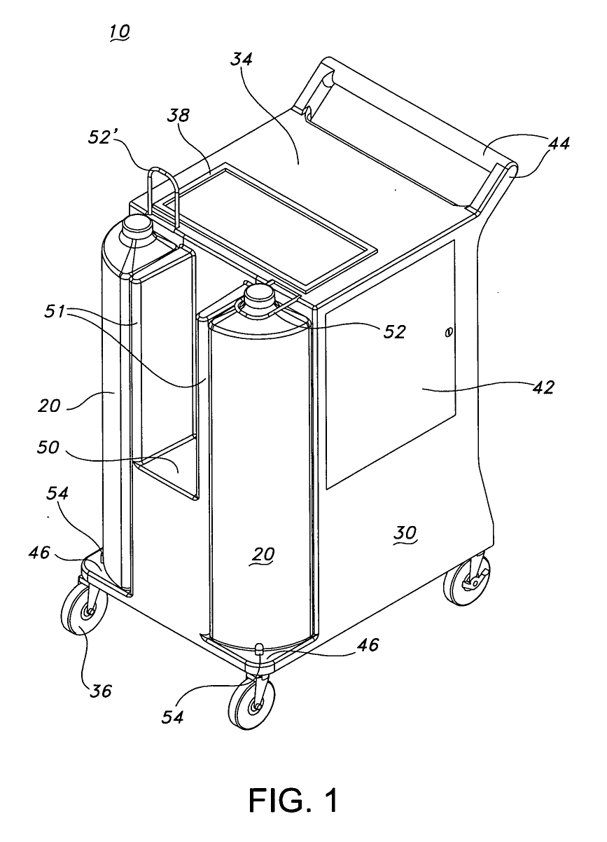

Referring specifically to FIGS. 1-4, a medical cart assembly embodying exemplary aspects of this invention is generally designated by the numeral “10.” The medical cart assembly 10 includes a transportable medical cart 30 and two medical implement containers 20 mounted thereon. The containers are configured to receive and store soiled medical implements and are desirably disposable or reusable.

In practice, a medical practitioner transports the cart from location to location to perform various medical procedures, such as a phlebotomy procedure. The cart of this exemplary embodiment is uniquely suited for such a medical procedure. More particularly, a hingedly connected left door 40 and right door 42 are provided on the left and right sides of the cart, respectively, to provide access to additional storage cavities within the interior of the cart. The storage cavities are useful for the storage of sterile sharps, gloves, medical supplies, clip boards, or any other common device employed in the medical industry. A set of pull-out drawers (not shown) may also be positioned within the cavities. The doors may include locks to restrict access to the respective storage cavities if so desired.

The top surface 34 of the cart is substantially flat for the practitioner to record data on a clip board that is rested on said surface. A protruding lip, ridge, detent or other projection 38 having a generally rectangular pattern is provided as a barrier on the top surface 34 of the cart so that a tray (not shown) containing loose items, such as sharps or vials, can safely rest on top of a motive cart. The protruding lip 38 limits movement of the tray or the loose items resting on the tray.

Two latches 52 and 52′ are mounted to the top surface 34 of the cart and are adapted to secure the top portions of the containers 20, respectively. The latches are pivotable to either a closed position or an open position (latch 52 is illustrated in a closed position and latch 52′ is illustrated in an open position). In the closed position, the latch 52 retains the top portion of the container 20 in a substantially fixed position, such that the container is limited from movement on a motive cart. In the open position of latch 52′, a filled container 20 may be removed from the cart or an empty container may be installed onto the cart. The latch is lockable in the closed position to prevent the latch from pivoting to an open position while the cart is in use. More specifically, the latch 52 is pushed in a direction towards the cart to fix the latch in the closed position 52. Conversely, the latch is pulled in a direction away from the cart to unlock the latch so that the latch can be pivoted towards the open position 52′. It should be understood that the latches 52, 52′ are not limited to the illustration shown. The latches may be any known device to secure the top portions of the containers 20, such as a strap, clip, clamp, tie, band, binding, release adhesive or any other device, apparatus or material capable of constraining the top end of the container.

A protruding detent 54 is positioned on the base surface 46 to fix the lower end of the container 20 in place and to limit the movement of the container while the cart is in use. The detents are positioned to frictionally engage and urge the containers against the interior walls of the cart 30 so that the containers are retained in position.

The detents 54 may be integral with and formed from the cart material or, alternatively, the detents may be a separate component. The detents may be a small protrusion, as shown in FIG. 1, or may be a sleeve, latch, strap, bolt, clip, clamp, tie, band, binding, release adhesive or any other device, apparatus or material capable of constraining the bottom end of the container. The base surface 46 of the cart may include a lip or other protrusion (not shown) to further encapsulate the bottom surface of the container in addition to or in lieu of the detents 54.

The cart 30 optionally includes two vertical walls 51 extending from the base surface 46 of the front end of the cart 30. A supplementary cavity 50 is disposed between the two walls 51 to accommodate a refuse container or other device (not shown). Two container cavities 48 are disposed on either side of the supplementary cavity 50 to accommodate the disposal containers 20. The cavity 48 includes an open right angled corner that extends the height H₁ of the cart body. A right angled closed corner of the container 20 is positioned into the open right angled corner of the cavity 48. The right angle corner is an ornamental feature of the cart 30, as the cavity 48 may have any shape and/or size, including curved surfaces, larger and smaller surfaces, and other contours.

The cross-sectional area of the cavity 48 defines the available cross-sectional area for the containers 20. The cross-sectional area of the cavity is desirably large enough to maximize the available cross-sectional area for the containers and thus, the available area for the soiled medical implements contained within the containers 20. Conversely, the cross-sectional area of the cavity is desirably small enough to minimize the overall size of the cart 30 so that the cart consumes minimal floor space and is maneuverable in confined spaces and narrow hallways in a hospital or doctors office setting. The cross-sectional area of the container 20 will be discussed in further detail later.

The bottom surface of the containers 20 are positioned in direct contact with the base surface 46 of the cavities 48. The base surface 46 of the cart is positioned so that the top of the container 20, when mounted thereupon, desirably extends to an elevation at or above the top surface 34 of the cart 30. Similarly, the height of the container 20 may be tailored so that the container 20 extends to an elevation at or above the top surface 34 of the cart, which will be discussed in further detail later.

It has been discovered that it may be advantageous to provide a container 20 that extends to an elevation at or above the top surface 34 of the cart 30. For accessibility purposes, the height of the container 20 is desirably at or above surface 34 of the cart so that the medical practitioner may easily deposit soiled articles into the container 20 to limit any potential for mishandling the contaminated matter. Also, a greater number of soiled medical implements may be deposited into a tall container 20 that extends the entire height of the cart 30. In addition to sharps disposal containers, the transportable cart may also be used to store other phlebotomy related equipment such as sterile sharps, empty vials, blood collection devices, gloves, cotton balls or any other medical related item.

The medical cart 30 is provided with a set of lockable swivel casters 36 to accommodate mobility of the cart. By virtue of the swivel casters 36, the cart 30 is capable of motion in any direction. Moreover, in a locked position of the casters, the cart is maintained in a stationary position. A handle 44 extending from the top surface of the cart is provided for maneuverability. Although not shown, a motor or other device may be connected to the casters 36 for automated motion.

The body of the cart 30 may be manufactured by any forming process, such as rotational molding or injection molding, or, alternatively, the cart body may be constructed from numerous components fastened together. The cart body material may be polymeric, metallic or any other material to serve its intended purpose. The cart body material is desirably light-weight, relatively inexpensive, washable and durable.

The design of the cart body including the handle 44 and exterior cavities 48 and 50 are ornamental features of the cart 30. Ornamental features of the cart 30 are also illustrated in co-pending Design Patent Application No. 29/XXX,XXX, which is incorporated herein by reference. The cart 30 can have a wide variety of ornamental shapes and configurations, including a variety of proportions, thicknesses, cross-sections, and curvatures. For example, ornamentation is provided by the overall outline of the cart 30.

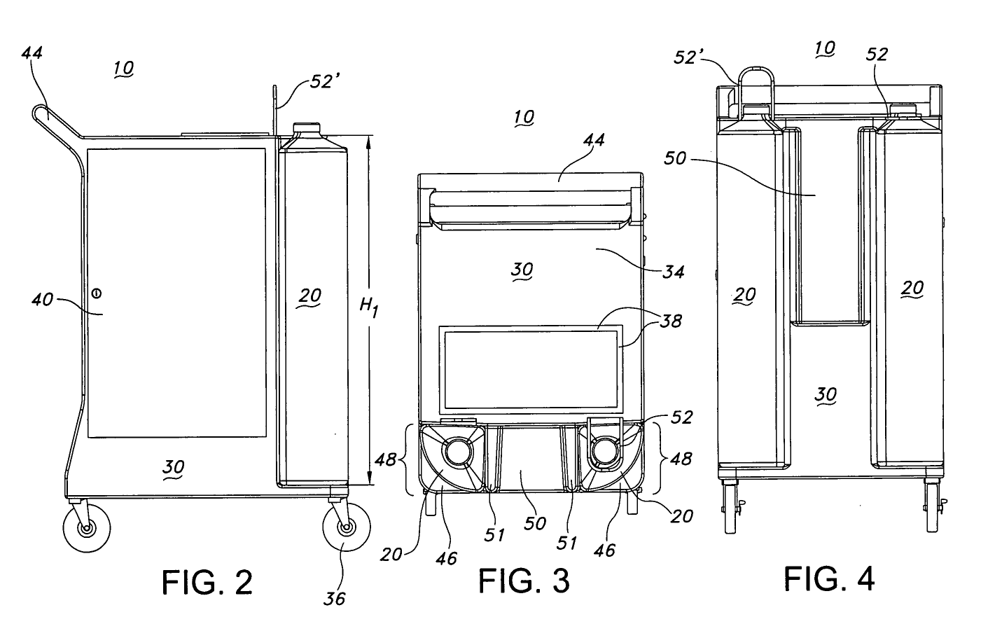

Referring now to FIGS. 2, 5 and 7, the inlet 23 of the container is positioned at a level at or above the top surface 34 of cart body 30. More particularly, the height H₁ (in) of the cart body 30 is less than or equal to the height H₂ (in) of the container 20. The cart assembly is ergonomically designed so that the inlet of the containers 20 are desirably within range (i.e. reach) of the medical practitioner. It has been discovered that it is convenient to position the inlet of the containers 20 in close proximity to the practitioner to limit the chance of mishandling a soiled sharp or other medical waste product.

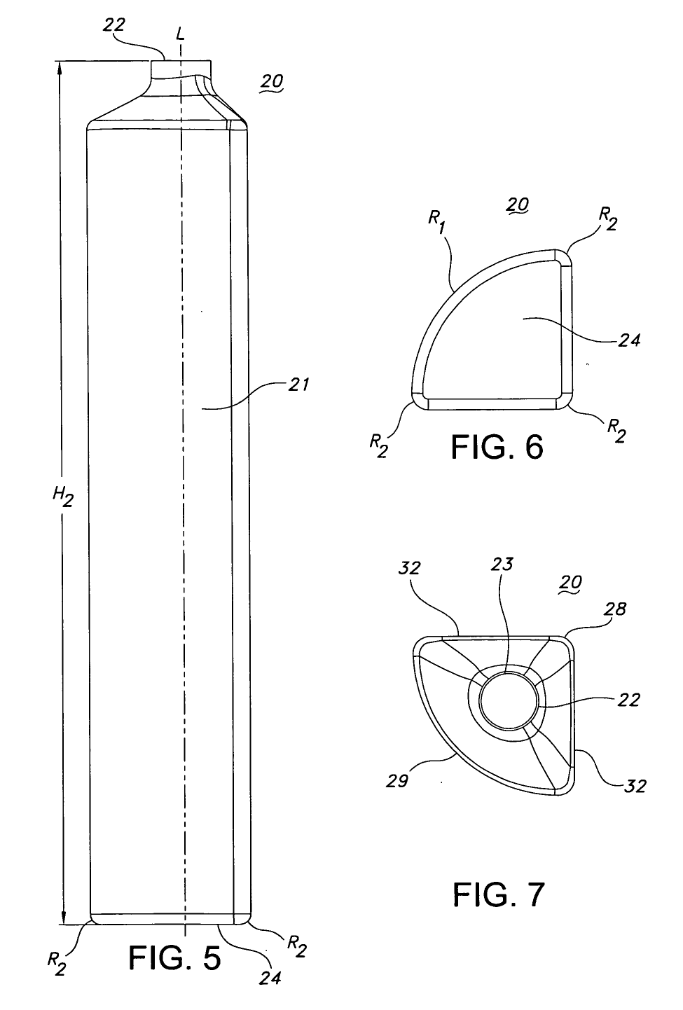

Referring to the exemplary embodiment of the medical implement container 20 illustrated in FIGS. 5-7, the container 20 is configured to receive and store soiled medical implements, such as sharps (i.e. syringes or needles), cotton swabs, pipets, or any other disposable medical product or apparatus. The container 20 comprises a unitary hollow body portion 21 adapted to contain waste matter. An aperture 23 (i.e. inlet) is disposed on the top surface 22 of the container 20 for the passage of soiled medical implements. The shape and size of the aperture 23 may be tailored to accept or restrict any particular medical implement.

A male threaded region may be disposed on the material forming the aperture to accommodate a female threaded cap (not shown). In a closed configuration of the container, i.e. the cap is installed onto the container top, access is restricted to the interior of the body portion 21. It should be understood that alternative means are envisioned to close the aperture, such as a flip top cap, a locking cap, a snap-cap, a rotating cap or a tortuous path-type device mounted to the aperture. Alternatively, in another exemplary embodiment not illustrated herein, the container may not include a cap.

The container 20 defines a closed right angled edge 28 and two straight walls 32 extending substantially perpendicular from the edge 28. A curvilinear wall 29 having a radius R₁ joins the ends of the straight walls 32 to form a substantially pie-shaped wedge cross-section. A bottom wall extending from the curvilinear wall and the straight walls defines the bottom end 24 of the body portion 21. The curvilinear wall 29 and the straight walls 32 unite together at the top end of the body portion 21 forming a sloped surface. The sloped surface extends vertically and terminates at a top surface 22 of the container 20 to form the aperture 23. The aperture may be centered along the longitudinal axis L of the container, as shown, or may be spaced from the longitudinal axis. The corners and edges of the body portion 21 may exhibit slight or generous radii R₂.

The shape of the container 20 is not limited to the illustrations, as the container may be of any shape such as, for example, cylindrical, spherical, rectangular or other geometry. The cross-sectional area of the vessel may be intentionally varied or maintained constant, such as the container illustrated in FIG. 5. The wall thickness of the container may be any adequate dimension such that the container can retain its shape, resist deformation and/or optionally resist puncture.

The design of the curvilinear wall 29, the straight walls 32 and the sloped surface at the top end of the body portion 21, for example, are ornamental features of the container 20. Ornamental features of the container 20 are also illustrated in co-pending Design Patent Application No. 29/XXX,XXX, which is incorporated herein by reference. The containers 20 can have a wide variety of ornamental shapes and configurations, including a variety of proportions, thicknesses, cross-sections, and curvatures. For example, ornamentation is provided by the pie-shaped cross section of the containers 20 and the sloping top portion of the container.

The body of the container 20 is defined by an exterior height H₂ (in) that is measured in a direction along its longitudinal axis L and an interior cross-sectional area that is measured in a direction perpendicular to the longitudinal axis. By way of non-limiting example, the height H₂ (in) of the container may be, for example, about 30 inches, and the cross sectional area of the container may be, for example, about 24 in². The aspect ratio of the container is defined by a ratio of the container height H₂ (in) to interior cross-sectional area (in²) of the body portion 21.

As mentioned previously, the height H₂ of the container 20 may be selected such that the top surface 22 of the container 20 extends to an elevation at or above the top surface 34 of the cart for accessibility purposes. Also, a container having a greater height and/or greater cross-sectional area desirably accommodates a greater number of soiled medical implements. Yet, the cross sectional area of the container should be adequately sized to limit the overall size of the container, and, thus, minimize the size of the container cavities 48 and the cart body 30 itself. Thus, the cross-sectional area of the container 20 is desirably large enough to maximize its available storage capacity for soiled medical implements, yet small enough to mount within the space footprint (i.e. container cavity 48) provided on the cart 30.

Moreover, it has been discovered that the aspect ratio of the container 20, i.e. the container height H₂ (in) to interior cross-sectional area (in²) ratio (i.e. aspect ratio), of about 0.3:1 or greater is advantageous from the accessibility, space constraint and capacity standpoints, according to one exemplary embodiment of this invention. According to another exemplary embodiment of this invention, the container aspect ratio is preferably about 0.6:1 or greater. According to yet another exemplary embodiment of this invention, the container aspect ratio is more preferably about 0.9:1 or greater. According to another exemplary embodiment of this invention, the container aspect ratio is most preferably about 1.2:1 or greater.

The material of the container 20 is desirably light-weight, durable and optionally puncture resistant to resist tearing, puncture, or other deformation as soiled sharps are deposited into the container in use. The container may be composed of a polymeric material, such as nylon, polyethylene, polypropylene or other material. The container may be a unitary body formed by a molding process such as blow molding, injection molding or other forming process. The cap (shown) may be integrally formed with the container 20 or may be a separate component.

Although the invention is illustrated and described herein with reference to specific embodiments, the invention is not intended to be limited to the details shown. Rather, various modifications may be made in the details within the scope and range of equivalents of the claims and without departing from the invention.

What is Claimed:

1. A medical implement container configured to receive soiled medical implements comprising a body portion having a dimension (in) measured along a longitudinal axis and a cross sectional area (in²) measured in a plane perpendicular to said longitudinal axis of said body portion, wherein a ratio of said dimension (in) of said body portion to said cross-sectional area (in²) of said body portion is about 0.3:1 or greater.

2. The medical implement container of claim 1, wherein the ratio of said dimension (in) of said body portion to said cross-sectional area (in²) of said body portion is about 0.6:1 or greater.

3. The medical implement container of claim 1, wherein the ratio of said dimension (in) of said body portion to said cross-sectional area (in²) of said body portion is about 0.9:1 or greater.

4. The medical implement container of claim 1, wherein the ratio of said dimension (in) of said body portion to said cross-sectional area (in²) of said body portion is about 1.2:1 or greater.

5. The medical implement container of claim 1 further comprising an opening defined in a top surface of the body portion to receive the soiled medical implements.

6. The medical implement container of claim 1 wherein the container is disposable or reusable.

7. A medical cart assembly comprising:
a medical cart having a base surface, a top surface, and a substantially enclosed storage area positioned between said base surface and said top surface for storage of medical supplies; and
at least one container configured to receive soiled medical implements positioned on said base surface of said medical cart external of said storage area, wherein a base surface of said container is positioned on said base surface of said medical cart and a top surface of said container is substantially aligned with or extends above said top surface of said medical cart to facilitate the deposition of soiled medical implements into said container.

8. The medical cart assembly of claim 7, said medical cart further comprising means for releasably retaining said top surface of said container in a substantially fixed position with respect to said top surface of said medical cart.

9. The medical cart assembly of claim 8 wherein said retaining means is selected from the group consisting of a latch, a strap and a hook.

10. The medical cart assembly of claim 7, said medical cart further comprising means for releasably retaining said bottom surface of said container in a substantially fixed position with respect to said bottom surface of said medical cart.

11. The medical cart assembly of claim 10, said retaining means comprising a protrusion upwardly extending from said base surface of said medical cart.

12. The medical cart assembly of claim 7, wherein said medical cart comprises wheels or casters positioned to facilitate transportation of said medical cart.

13. The medical cart assembly of claim 7, wherein said top surface of said container is positioned above said top surface of said medical cart.

14. The medical cart assembly of claim 7, comprising two containers configured to receive soiled medical implements, each of said containers being positioned on a respective base surface of said medical cart, and each of said containers comprising a body portion having a dimension (in) measured along a longitudinal axis and a cross sectional area (in²) measured in a plane perpendicular to said longitudinal axis of said body portion, wherein a ratio of said dimension (in) of said body portion to said cross-sectional area (in²) of said body portion is about 0.3:1 or greater.

15. The medical cart assembly of claim 7, said medical cart including a handle, whereby a user employs said handle to transport said cart.

16. The medical cart assembly of claim 7, said medical cart defining a vertically extending recess, whereby said container is positioned in said recess.

17. A method of facilitating the disposal of medical implements comprising:
storing medical supplies in a substantially enclosed storage area located between a base surface and a top surface of a medical cart; and
positioning a container on the cart external of the storage area such that a base portion of the container is positioned on the base surface of the cart and a top portion of the container is substantially aligned with or extends above the top surface of the cart.

18. The method of claim 17 further comprising the step of securing the top portion of the container with respect to the top surface of the cart.

19. The method of claim 17 further comprising the step of securing the base portion of the container with respect to the base surface of the cart.

20. The method of claim 17 further comprising the step of depositing soiled medical implements into the container.

21. A medical cart assembly comprising:
a medical cart having a base surface, a top surface, and a substantially enclosed storage area positioned between said base surface and said top surface for storage of medical supplies; and
at least one container configured to receive soiled medical implements positioned on said base surface of said medical cart external of said storage area, wherein a base surface of said container is positioned on said base surface of said medical cart and a top surface of said container is substantially aligned with or extends above said top surface of said medical cart to facilitate the deposition of soiled medical implements into said container;
said container comprising a body portion having a dimension (in) measured along a longitudinal axis and a cross sectional area (in²) measured in a plane perpendicular to said longitudinal axis of said body portion, wherein a ratio of said dimension (in) of said body portion to said cross-sectional area (in²) of said body portion is about 0.3:1 or greater.
